(19) United States
(12) Patent Application Publication
(10) Pub. No.: US 2010/0146205 A1
(43) Pub. Date: Jun. 10, 2010

(54) Storage device and method of writing data

(75) Inventors: Michael Edward Baum, Longmont, CO (US); Margot Ann Lapanse, Superior, CO (US); John Edward Moon, Superior, CO (US); Paul Francis Kusbel, Longmont, CO (US)

Correspondence Address: SEAGATE TECHNOLOGY LLC;C/O WESTMAN, CHAMPLIN & KELLY, P.A., SUITE 1400, 900 SECOND AVENUE SOUTH, MINNEAPOLIS, MN, 55402-3244, US

(73) Assignee: Seagate Technology LLC, Scotts Valley, CA (US)

(21) Appl. No.: 12/329,785

(22) Filed: Dec. 8, 2008

(51) Int. Cl. G06F 12/08; G06F 12/00

(52) U.S. Cl. 711/113; 711/112; 711/154; 711/E12.001; 711/E12.019

(57) ABSTRACT

In a particular embodiment, a device is disclosed that includes a controller adapted to store data to a first storage medium. The controller is adapted to receive data storage commands in an order received and to store the received data storage commands at a second storage medium. Further, the controller is adapted to re-order the data storage commands from the order received to an execution order, monitor access activity related to the first storage medium, and store the data from the second storage medium to the first storage medium according to the execution order when the monitored access activity falls below an activity threshold.

### FIELD OF THE INVENTION

The present invention relates generally to storage devices and methods of writing data, and more particularly, but not by limitation, to methods of enhancing reliability of the storage device using a non-volatile cache.

### BRIEF DESCRIPTION OF THE DRAWINGS

FIG. 1 is an isometric view of a system including a disc drive having a non-volatile cache and logic to store data from the non-volatile cache to a storage media;

FIG. 2 is a block diagram of a particular illustrative embodiment of a system including a storage device having a non-volatile cache;

FIG. 3 is a flow diagram of a particular illustrative embodiment of a method of writing data;

FIG. 4 is a flow diagram of a second particular illustrative embodiment of a method of writing data; and

FIG. 5 is a flow diagram of a third particular illustrative embodiment of a method of writing data.

Embodiments disclosed herein can provide solutions to these and other problems, and offer other advantages over the prior art.

### DETAILED DESCRIPTION OF ILLUSTRATIVE EMBODIMENTS

Disc drives can include a seek system to position a read/write mechanism relative to a track of a storage media to be accessed. The time it takes to position the read/write mechanism and for the read/write mechanism to stabilize relative to the center of the track is sometimes referred to as a seek/settle time. Poor seek/settle times can result in slow access times, while poor track positioning can degrade disc drive reliability due to encroachment of adjacent track data, which can interfere with data stored at adjacent track locations and thereby limit track density. Further, random, high performance seek operations can produce audible noise and can be power intensive.

In a particular embodiment, a system is disclosed that includes a solid-state memory, a controller, and a second memory device. In a particular example, the solid-state memory can be a flash memory and the second memory device can be a disc storage media. In a particular embodiment, the controller is adapted to monitor access activity related to the second memory device, to store received data and associated write commands at the solid-state memory when the access activity exceeds an activity threshold. Further, the controller is adapted to recorder the received data and associated write commands based on an optimization algorithm, and to execute the write commands in the revised order to write the data from the solid-state memory to the second memory device when the activity falls below the activity threshold.

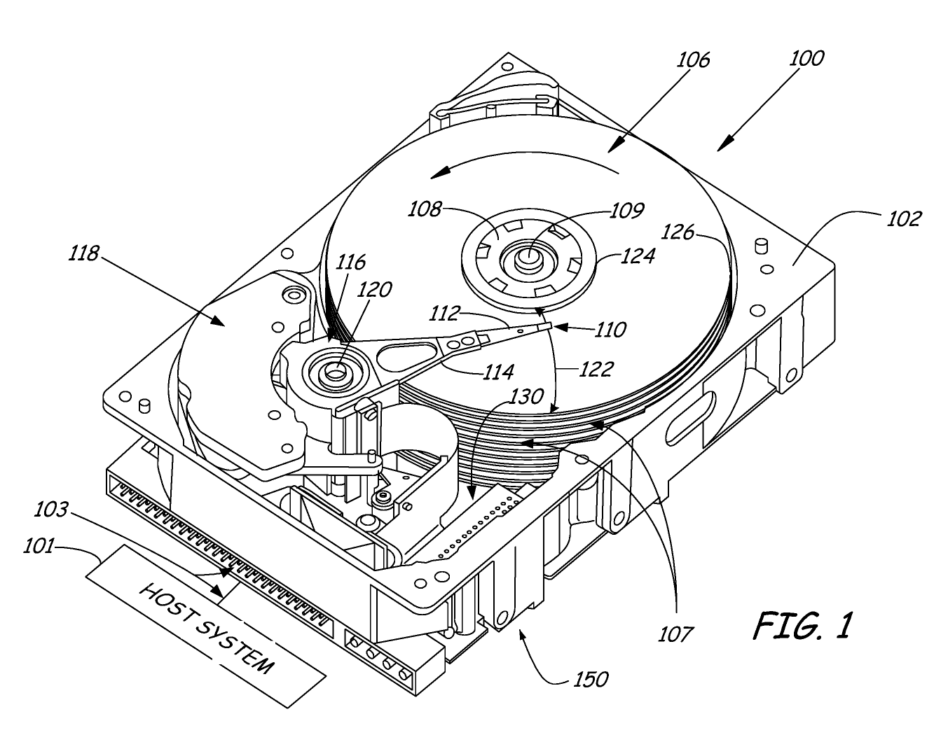

FIG. 1 is an isometric view of a system including a disc drive 100 having a non-volatile cache and logic to write data from the non-volatile cache to a storage media. The disc drive 100 can be coupled to a host system 101 via a host interface 103. In a particular embodiment, the host system 101 can be a computer processor and the host interface 103 can include a data bus and an associated connector, such, for example, a serial Advanced Technology Attachment (SATA) with an associated SATA connector. In a particular example, the disc drive 100 can be located within a computer system, such as a portable computer.

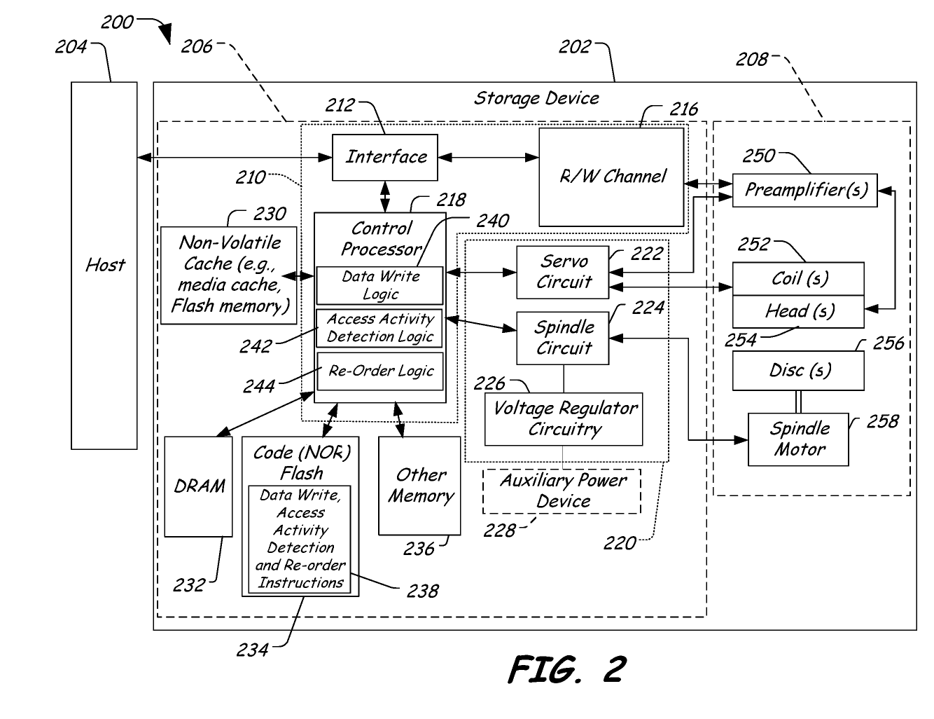

The disc drive 100 includes a housing having a base 102 and a top cover (not shown). The disc drive 100 further includes a disc pack 106, which is mounted on a spindle motor (such as spindle motor 258 illustrated in FIG. 2) by a disc clamp 108. The disc pack 106 includes a plurality of individual discs 107, which are mounted for co-rotation about central axis 109. Each disc surface has an associated disc head slider, such as the disc head slider 110, which supports a read/write head for communicating data to and from a particular disc of the plurality of discs 107 of the disc pack 106. In the example shown in FIG. 1, the disc head slider 110 is supported by a suspension 112, which is in turn attached to a track accessing arm 114 of an actuator 116. The actuator 116 is adapted to control the suspension 112, the track accessing arm 114, and the disc head sliders 110 associated with each of the plurality of individual discs 107 of the disc pack 106.

The actuator 116 shown in FIG. 1 is of the type known as a rotary moving coil actuator and includes a voice coil motor (VCM), shown generally at 118. The VCM 118 rotates the actuator 116 with its attached disc head slider 110 about a pivot shaft 120 to position the disc head slider 110 over a desired data track along an arcuate path 122 between a disc inner diameter 124 and a disc outer diameter 126. The VCM 118 is driven by servo electronics 130 based on signals generated by heads 110 and/or by the host system 101, which can send data storage commands and data to the disc drive 100 via the host interface 103, which can include a cable and a connector.

The disc drive 100 further includes a controller and associated logic 150 and includes a non-volatile cache memory (such as the non-volatile cache 230 illustrated in FIG. 2). In this particular example, the controller and associated logic 150 are located on a circuit board that extends along a lower surface of the disc drive 100. The controller and associated logic 150, which are discussed in detail below, are adapted to receive data and data storage commands from the host system 101 via the host interface 103. The controller and associated logic 150 are adapted to store the received data and data storage commands at the non-volatile cache memory and to execute the data storage commands and write the received data to the disc pack 106 during periods of low host/hard disc drive (HDD) activity, during periods of inactivity, when an access activity related to the disc pack 106 falls below a threshold activity level, or any combination thereof. In a particular embodiment, the controller and associated logic 150 can move data from the non-volatile cache to one or more of the individual discs 107 in a manner that enhances the write speed, that reduces seek/settle times, or any combination thereof. Once the host data has been stored in the cache, the host data does not have to be moved to the one or more discs 107 in the same sequence in which it was originally received from the host device (i.e., the receipt order). In a particular example, the data storage commands and the write operations can be re-ordered using a radial position optimization algorithm to minimize seek distance between adjacent write operations, which can improve seek/settle and overall power consumption.

In a particular embodiment, the host activity can include read/write access activity received at the storage device 102 from the host system 101. Further, the controller and associated logic 150 can determine an operating mode associated with the host system 101, such as a normal operating mode or a reduced power mode, including an idle mode, a sleep mode, or another reduced power mode. The host activity can be determined to be below an activity threshold when the controller and associated logic 150 detect that the host system 101 is operating in a reduced power mode or when read or write access requests fall below an activity threshold.

In a particular embodiment, the disc drive 100 is adapted to allow data writes during periods of low host activity using enhanced (tightened) seek/settle and on-track write fault threshold criteria, improving reliability and reducing seek-related acoustic noise, power consumption and overall costs. In a particular example, the seek/settle criteria can be tightened to ensure track centering of the read/write head while on-track write fault threshold criteria can be tightened to reduce adjacent track encroachment and to improve track mis-registration and drive reliability. By tightening the seek/settle criteria and the on-track write fault threshold criteria, the disc drive 100 can significantly improve reliability. By performing write operations during periods of low activity or inactivity, a more stringent seek/settle criteria can be used with negligible impact on throughput performance of the disc drive 100.

FIG. 2 is a block diagram of a particular illustrative embodiment of a system 200 including a hybrid storage device 202. As used herein, the term “hybrid storage device” refers to a data storage device that includes magnetic or optical storage media in conjunction with solid-state storage media. Further, as used herein, the term “solid-state storage media” refers to any semiconductor that can be used to store and retrieve data without moving parts. In a particular example, the solid-state storage media can utilize charge density, magneto-resistance, or other physical properties of the storage media to represent data values.

In the system 200, the storage device 202 includes one or more rotatable discs 256, such as the plurality of individual discs 107 of the disc pack 106 illustrated in FIG. 1. The storage device 202 is adapted to communicate with a host system 204 via a data bus, such as, for example, a serial advanced technology attachment (SATA) with an associated connector. In a particular embodiment, the host system 204 can be a computer, a processor, a personal digital assistant (PDA), a mobile phone, a media (audio and/or video) player, another electronic device, or any combination thereof. In another particular embodiment, the hybrid storage device 202 can be a stand-alone storage device that includes a network interface card (NIC) to communicate with the host system 204 via a network bus, such as an Ethernet cable.

The storage device 202 includes recording subsystem circuitry 206 and a head-disc assembly 208. The recording subsystem circuitry 206 includes storage device read/write control circuitry 210 and disc-head assembly control circuitry 220. The recording subsystem circuitry 206 further includes an interface circuit 212, which has a data buffer for temporarily buffering the data and a sequencer for directing the operation of the read/write channel 216 and the preamplifier 250 during data transfer operations. The interface circuit 212 is coupled to the host system 204 and to a control processor 218, which is adapted to control operation of the storage device 202.

The control processor 218 is coupled to a servo circuit 222 that is adapted to control the position of one or more read/write heads 254 relative to the one or more discs 256 as part of a servo loop established by the one or more read/write heads 254. The one or more read/write heads 254 are mounted to a rotary actuator assembly to which a coil 252 of a voice coil motor (VCM), such as the VCM indicated at 118 in FIG. 1, is attached. The VCM includes a pair of magnetic flux paths between which the coil 252 is disposed so that the passage of current through the coil causes magnetic interaction between the coil 252 and the magnetic flux paths, resulting in the controlled rotation of the actuator assembly and the movement of the one or more heads 254 relative to the surfaces of the one or more discs 256. The servo circuit 222 is used to control the application of current to the coil 252, and hence the position of the heads 254 with respect to the tracks of the one or more discs 256.

The disc-head assembly control circuitry 220 includes the servo circuit 222 and includes a spindle circuit 224 that is coupled to a spindle motor 258 to control the rotation of the one or more discs 256. The storage device 202 also includes an auxiliary power device 228 that is coupled to voltage regulator circuitry 226 of the disc-head assembly control circuitry 220 and that is adapted to operate as a power source when power to the storage device 202 is lost. In a particular embodiment, the auxiliary power device 228 can be a capacitor or a battery that is adapted to supply power to the storage device 202 under certain operating conditions. In a particular example, the auxiliary power device 228 can provide a power supply to the recording subsystem assembly 206 and to the disc-head assembly 208 to record data to the one or more discs 256 when power is turned off. Further, the auxiliary power device 228 may supply power to the recording subsystem assembly 206 to record data to a non-volatile cache 230 or to the one or more discs 256 when power is turned off.

The storage device 202 also includes the non-volatile cache (NVC) 230, a dynamic random access memory (DRAM) 232, the firmware flash 234, other memory 236, or any combination thereof. The firmware flash 234 is accessible to the control processor 218 and is adapted to store data write, activity detection, and re-order instructions 238.

In a particular embodiment, the control processor 218 is adapted to selectively load and execute the data write, access activity detection, and re-order instructions 238 from the firmware flash 234, which execution is represented by data write logic 240, access activity detection logic 242, and re-order logic 244. The control processor 218 uses the data write logic 240 to receive data and data storage commands from the host system 204 via the interface 212 and to selectively write the data and the data storage commands to the NVC 230. The control processor 218 is adapted to use the access activity detection logic 242 to detect a period of inactivity, to detect an activity level that is below a threshold activity level, or any combination thereof. In a particular example, the activity level can be inferred based on a detected operating mode of the host system 204, such that when the host system 204 is operating in a reduced power mode (such as a sleep mode), the host activity level can be assumed to be below the threshold activity level by the control processor 218. Alternatively, the control processor 218 can determine the period of inactivity by monitoring data storage commands and data access requests received from the host system 204 over a period of time, and when the monitored number of commands and requests falls below a threshold activity level, the control processor 218 can detect the period of low activity.

Upon detection of an activity level that is below the activity threshold, the control processor 218 uses the data write logic 240 to move the received data from the NVC 230 to the one or more discs 256 (performing a background data write operation). In a particular example, to reduce seek settle time and enhance write performance, the control processor 218 can use the re-order logic 244 to re-order the data storage commands and/or the write operations associated with the data stored at the NVC 230 and can use the data write logic 240 to write the data according to the re-ordered data storage commands and/or re-ordered write operations. In another particular example, a radial position optimization algorithm can be used to organize (re-order) the data write operations to reduce a seek distance between adjacent write operations, which reduces settle times and reduces overall power consumption and acoustics.

In another particular embodiment, the data write logic 240 is adapted to utilize tightened seek/settle criteria for writing data from the NVC 230 to the one or more discs 256. In a particular example, the control processor 218 is adapted to utilize a first seek/settle criteria for short seek write operations and a second seek/settle criteria for long seek write operations, where the second seek/settle criteria is tightened relative to the first seek/settle criteria. In this particular example, the second seek/settle criteria may be tightened to reduce adjacent track encroachment and to enhance storage media reliability. In a particular example, the first seek/settle criteria can be less stringent than the second seek/settle criteria, allowing for faster short seek access to the one or more discs 256, while ensuring more accurate write access using the second seek/settle criteria. In a particular example, the seek/settle criteria can be determined during manufacturing and can be stored with associated thresholds at firmware, at the firmware flash 234, at other memory locations, or any combination thereof. In another particular example, the seek/settle criteria can be dynamically determined by the control processor 218 during operation based on error information determined from read data.

In an alternative embodiment, a controller, such as the controller and associated logic 150 illustrated in FIG. 1 and/or the control processor 218 illustrated in FIG. 2, can be implemented within a solid-state storage device, which includes a first storage media to store data and a second storage media to store data and data storage commands received from a host before transferring the data to the first storage media. In this particular example, both the first and the second storage media can be solid-state storage media, such as a flash memory, for example. In this particular example, the second storage media may store data received from a host system, re-order data storage commands associated with the received data to enhance write times, to reduce power consumption, or any combination thereof, and write the data according to the re-ordered data storage commands when the host activity falls below a threshold level. In a particular example, overall performance can be enhanced by conserving processing power related to memory access for times when the host system has low memory access activity.

In a particular embodiment, the first and second solid-state storage media can be separate and independent storage media. In another particular embodiment, the first and second solid-state storage media can refer to different storage areas of the same solid-state storage device, such as a flash memory device.

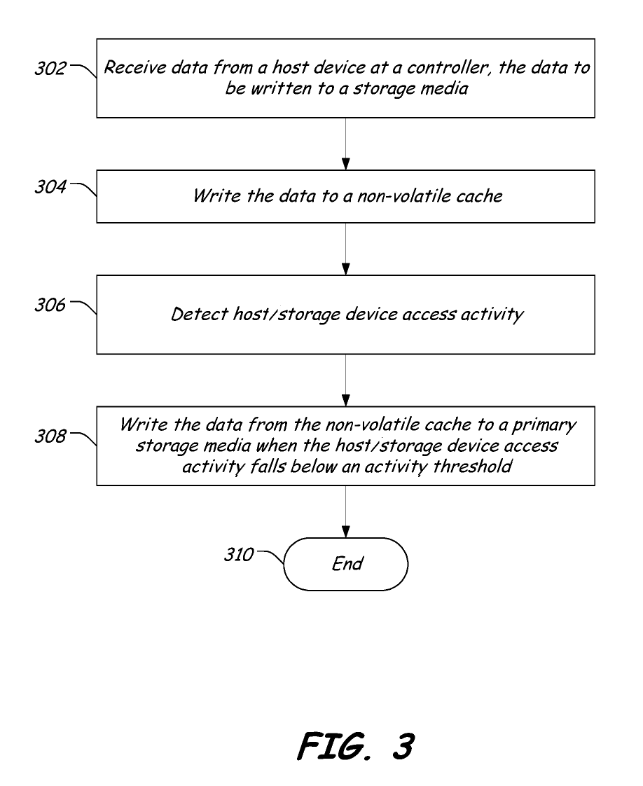

FIG. 3 is a flow diagram of a particular illustrative embodiment of a method of writing data. At 302, data is received from a host device at a controller where the data is to be written to a first storage media. Moving to 304, the controller writes the received data to a second storage media. In a particular embodiment, the first and second storage media can be separate solid-state memories. In another particular embodiment, the first storage media can be a disc storage media, and the second storage media can be a solid-state memory. In still another particular embodiment, the first storage media can be a disc storage media, and the second storage media can be a non-volatile media cache.

Continuing to 306, the controller determines an access activity associated with the host, the storage media, or any combination thereof. In a particular, embodiment, the controller monitors storage media access activity, host interface commands, other activity, or any combination thereof to determine the access activity. In another particular embodiment, the controller determines a mode associated with the host system, such as an idle mode, a normal operating mode, a reduced power mode, another mode, or any combination thereof. In a particular example, the activity threshold represents an activity level associated with an idle or power savings mode of operation of the host device. For example, the host device can be mobile phone that includes an active mode and a sleep (power savings) mode of operation. The controller is adapted to detect when the host device is operating in the sleep mode based on the activity level, where the activity level represents a threshold between the active mode and the sleep mode. In another particular embodiment, the activity threshold represents reduced storage media access activity. Advancing to 308, the controller writes the received data from the second storage media to the first storage media when the access activity falls below an activity threshold. In a particular embodiment, the activity threshold may vary based on the operating mode of the host device. For example, the activity threshold may be higher during normal operation and may be lower when the host device is determined to be in an idle mode or a reduced power mode. The method terminates at 310.

In a particular embodiment, the method further includes tightening seek/settle criteria before writing the received data to the storage media to reduce adjacent track encroachment. In another particular embodiment, the method also includes re-ordering data write operations associated with the received data stored at the non-volatile cache to reduce seek distances between data write operations before writing the received data to the storage media. In a particular example, the data write operations are re-ordered according to a radial position optimization algorithm. In still another particular embodiment, the method includes re-ordering data write operations associated with the received data stored at the non-volatile cache into an ordered sequence so that the re-ordered data write operations can be performed sequentially to write the received data to the storage media. In yet another particular embodiment, the method includes re-ordering the data write operations (data storage commands) from a receipt order to an execution order to enhance write speeds, to reduce write power consumption, or any combination thereof.

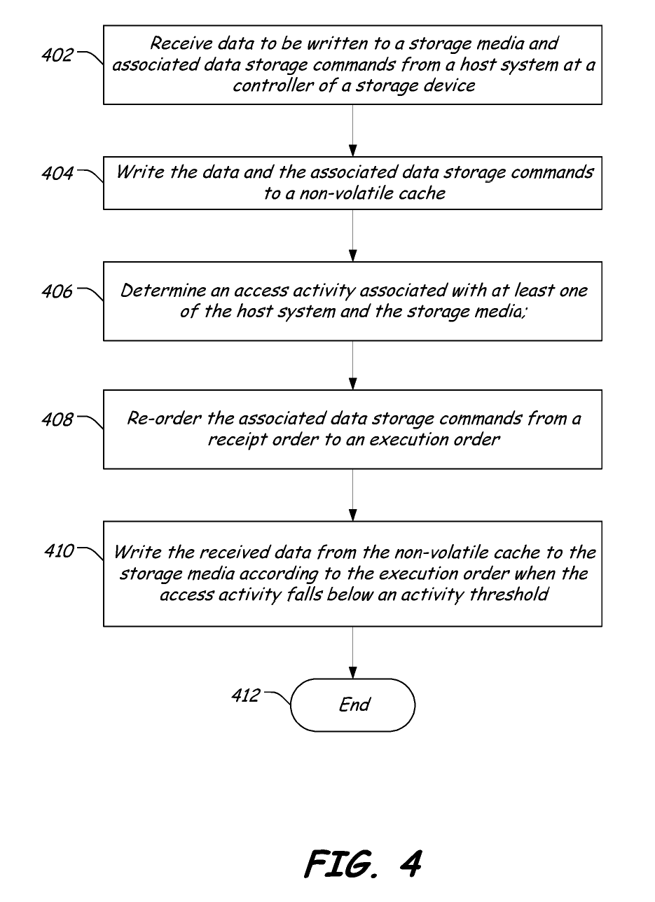

FIG. 4 is a flow diagram of a second particular illustrative embodiment of a method of writing data. At 402, data to be written to a storage media and associated data storage commands are received from a host device at a controller of a storage device. Advancing to 404, the data and the associated data storage commands are written to a non-volatile cache, such as a flash, a media cache, another non-volatile temporary storage, or any combination thereof. Continuing to 406, an access activity is determined that is associated with at least one of the host system and the storage media. In a particular embodiment, the access activity includes host/storage media access activity including read access commands, write access command, other requests, or any combination thereof. Moving to 408, the associated data storage commands are re-ordered from a receipt order to an execution order. Continuing to 410, the received data is written from the non-volatile cache to the storage media according to the execution order when the access activity falls below an activity threshold. In a particular example, the activity threshold may represent a mode of operation, such as a sleep mode, a period of inactivity, a storage media access frequency, or any combination thereof. The method terminates at 412.

In a particular embodiment, re-ordering of the data storage commands and/or write operations associated with the received data can enhance write efficiencies. In a particular example, data write operations can be re-ordered to reduce distances between adjacent seek operations in a disc drive system using a radial position optimization algorithm. In another particular embodiment, the associated data storage commands can be re-ordered to improve a write speed, to reduce a write power, or any combination thereof. In a particular example, the data write operations can be re-ordered using a memory bank power optimization algorithm to control a power enable order associated with memory banks of a solid-state memory device.

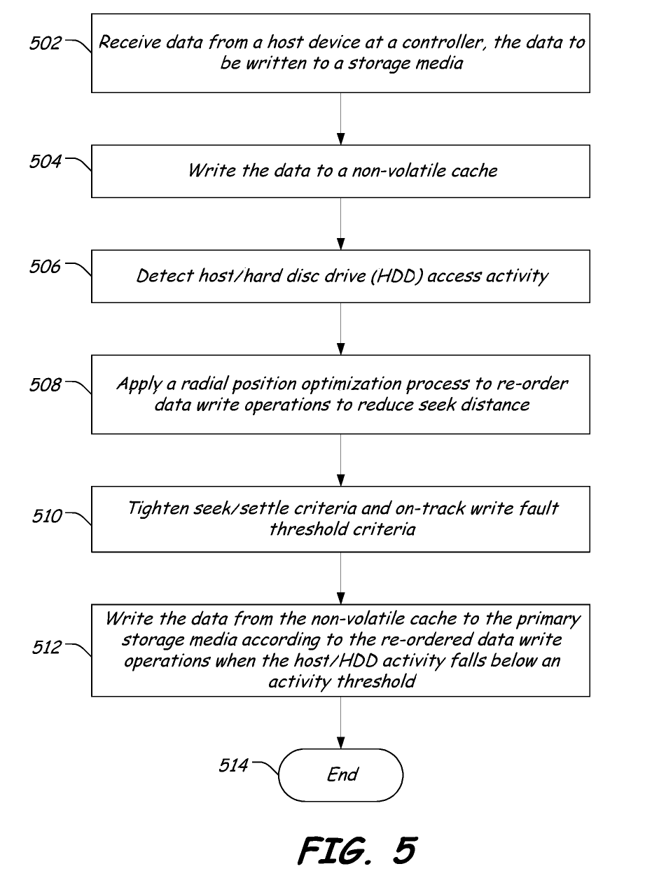

FIG. 5 is a flow diagram of a third particular illustrative embodiment of a method of writing data. At 502, data is received from a host device at a controller, where the data is to be written to a storage media. Moving to 504, the received data is written to a non-volatile cache. Advancing to 506, host/hard disc drive (HDD) access activity is detected. Continuing to 508, a radial position optimization process is applied to the received data to re-order data write operations to reduce seek distance. In a particular example, by reducing the seek distance, the seek/settle time and accuracy can be enhanced, allowing for reduced power consumption, and improved drive reliability. Proceeding to 510, seek/settle criteria and on-track write fault threshold criteria are tightened. In a particular example, the criteria may be tightened (heightened) to require more accurate track centering before initiating the write operations. Moving to 512, the data is written from the non-volatile cache to the primary storage media according to the re-ordered data write operations and the tightened seek/settle criteria and on-track fault threshold criteria when the host/HDD activity falls below an activity threshold. By writing data during periods of inactivity, any increased access time due to the tightened criteria has negligible impact on the performance of the storage device from a user's perspective. The method terminates at 514.

In conjunction with the systems and methods disclosed above with respect to FIGS. 1-5, a storage device is disclosed that receives data to be written to a first storage media and receives associated data storage commands, that stores the data and the data storage commands in a second storage media, that re-orders the associated data storage commands from a receipt order (i.e., an order in which the data storage commands were received) to an execution order, and that transfers the data from the second storage media to the first storage media according to the execution order. In a particular embodiment, the first storage media is a disc media and the second storage media is a solid-state memory, such as a flash memory or another type of solid-state memory. In another particular embodiment, the first storage media and the second storage media are separate solid-state memory devices. In still another particular embodiment, the first storage media is a disc storage media and the second storage media is a media cache, which may be an allocated portion of the disc storage media.

In a particular embodiment, the controller of the storage device is adapted to transfer the data from the second storage media to the first storage media during periods of low host/storage device activity. Further, the data storage commands can be re-ordered into an execution order that has reduced seek distances between commands (as compared to the receipt order). In this particular example, the controller can be adapted to utilize tightened seek settle and on-track write fault threshold criteria during writes. In a particular example, write operations can be re-ordered using an optimization algorithm, such as a radial position optimization algorithm, to enhance write efficiencies. By writing to a non-volatile cache first, the storage device can optimize the write operations without concern for data loss due to unexpected power events. In particular, during a power loss event, data remains in the non-volatile cache and can be recovered when power is restored.

In another particular embodiment, the controller of the storage device is adapted to transfer data from the second storage media (a second solid-state memory) to the first storage media (a first solid-state memory), where the data storage commands are re-ordered to enhance write efficiencies and to reduce write power consumption. In a particular example, the controller is adapted to re-order the data storage commands into an order that improves data write speeds.

It is to be understood that even though numerous characteristics and advantages of various embodiments of the invention have been set forth in the foregoing description, together with details of the structure and function of various embodiments described above, this disclosure is illustrative only, and changes may be made in detail, especially in matters of structure and arrangement of parts within the principles of the present disclosure to the full extent indicated by the broad general meaning of the terms in which the appended claims are expressed. For example, the particular elements may vary depending on the particular application for the storage system while maintaining substantially the same functionality without departing from the scope and spirit of the present disclosure. In addition, it will be appreciated by those skilled in the art that the teachings of the present disclosure can be applied to computing systems, computer servers, stand-alone storage devices, mobile phones, media players, mobile computing devices, or any combination thereof, without departing from the scope and spirit of the present disclosure.

What is claimed is:

1. A device comprising:
a controller adapted to store data to a first storage medium, the controller adapted to:
receive data storage commands in an order received;
store received data and the received data storage commands at a second storage medium;
re-order the data storage commands from the order received to an execution order;
monitor access activity related to the first storage medium; and
store the data from the second storage medium to the first storage medium according to the execution order when the monitored access activity falls below an activity threshold.

2. The device of claim 1, wherein the controller is adapted to re-order the data storage commands into the execution order having a reduced seek distance as compared to the receipt order of the data storage commands.

3. The device of claim 1, wherein the controller is adapted to receive first data and a first data storage command and then to receive second data and a second data storage command, the controller to selectively re-order the first and second data storage commands and to execute the second data storage command before executing the first data storage command.

4. The device of claim 1, wherein the first storage medium comprises a rotatable disc, and wherein the controller is adapted to use a first seek/settle criteria for storage access operations of short seeks and to use a second seek/settle criteria for storage operations of long seeks to store the data to the first storage medium to reduce adjacent track encroachment.

5. The device of claim 4, wherein the controller is adapted to use a first storage fault threshold in conjunction with the first seek/settle criteria and to use a second storage fault threshold in association with the second seek/settle criteria.

6. The device of claim 5, wherein the second seek/settle criteria and the second storage fault threshold are tightened relative to the first seek/settle criteria and the first storage fault threshold.

7. The device of claim 1, wherein the access activity comprises data storage and data retrieval commands received by the controller within a particular period of time.

8. The device of claim 1, wherein the first storage medium and the second storage medium comprise solid-state storage media.

9. A method comprising:
receiving data and data storage commands at a storage device having a first and second data storage media;
storing the received data and the associated data storage commands to the second data storage medium;
determining an access activity associated with at least one of a controller of the storage device and the first data storage medium;
re-ordering the associated data storage commands from an order received to an execution order; and
writing the received data from the second data storage medium to the first data storage medium according to the execution order when the access activity falls below an activity threshold.

10. The method of claim 9, further comprising tightening seek/settle criteria before writing the received data to the first data storage medium to reduce adjacent track encroachment.

11. The method of claim 9, wherein the execution order has reduced seek distances between data store commands relative to the order received.

12. The method of claim 11, wherein the data storage commands are re-ordered according to a radial position optimization algorithm.

13. The method of claim 9, wherein the second data storage medium comprises a media cache on the first data storage medium.

14. The method of claim 9, wherein the second data storage medium comprises a solid-state data storage medium and wherein the first data storage medium comprises a rotatable storage medium.

15. The method of claim 9, further comprising monitoring at least one of a controller activity associated with a controller of the data storage device and a storage medium read-access activity associated with the first data storage medium to determine the access activity.

16. The method of claim 9, wherein the execution order has a faster execution time with respect to the data storage commands relative to the order received.

17. The method of claim 9, wherein the first data storage medium and the second data storage medium comprise solid-state storage media.

18. A device comprising:
a host interface adapted to couple to a data bus to receive data storage commands and data from a host system;
a first data storage medium;
a second data storage medium; and
a controller coupled to the host interface to store received data to the second data storage medium, to determine an access activity related to access of the first data storage medium, to re-order the associated data storage commands into an execution order, and to move the data from the second data storage medium to the first data storage medium according to the execution order when the determined access activity falls below a threshold activity.

19. The device of claim 18, wherein the controller is adapted to re-order the data storage commands into the execution order, wherein the execution order has reduced seek distances between data storage commands as compared to an order received of the data storage commands.

20. The device of claim 19, wherein the first data storage medium comprises a rotatable data storage medium and wherein the store operations are re-ordered according to a radial position optimization algorithm to reduce a seek distance between adjacent store operations.

21. The device of claim 19, wherein the store operations are re-ordered such that adjacent write operations of the re-ordered store operations access storage locations of the first data storage medium sequentially.

22. The device of claim 18, wherein the first data storage medium is a rotatable storage medium, and wherein the second data storage medium comprises a solid-state storage medium.

23. The device of claim 22, wherein the second data storage medium comprises a media cache associated with the first data storage medium.

24. The device of claim 18, wherein the controller is adapted to apply a first seek/settle criteria for short seek store operations and a second seek/settle criteria for long seek store operations, wherein the second seek/settle and store fault threshold criteria are tightened relative to the first seek/settle and store fault threshold criteria.

25. The device of claim 18, wherein the first and second data storage media comprise solid-state data storage media.
